(19) United States
(12) Patent Application Publication
(10) Pub. No.: US 2026/0104550 A1
(43) Pub. Date: Apr. 16, 2026

(54) OPTO-ELECTRIC CONNECTION COMPONENT AND INFORMATION DEVICE

(71) Applicant: SUMITOMO ELECTRIC INDUSTRIES, LTD., Osaka (JP)

(72) Inventors: Masaki SUZUKI, Osaka (JP); Takeshi INOUE, Osaka (JP); Yasunori ASANO, Osaka (JP); Shun ENDO, Osaka (JP)

(73) Assignee: SUMITOMO ELECTRIC INDUSTRIES, LTD., Osaka (JP)

(21) Appl. No.: 19/346,905

(22) Filed: Oct. 1, 2025

(30) Foreign Application Priority Data
Oct. 10, 2024 (JP) 2024-177814

(51) Int. Cl. G02B 6/38

(52) U.S. Cl. CPC G02B 6/3817

(57) ABSTRACT

An opto-electric connection component includes a first terminal member, a second terminal member, at least one optical fiber including a first end and a second end located opposite to the first end, the first end and the second end being connected to the first terminal member and the second terminal member, respectively, and at least one metal wire including a first end and a second end located opposite to the first end, the first end and the second end being connected to the first terminal member and the second terminal member, respectively.

### CROSS-REFERENCE TO RELATED APPLICATION

This application claims priority based on Japanese Patent Application No. 2024-177814 filed on October 10, 2024, and the entire contents of the Japanese patent application are incorporated herein by reference.

### TECHNICAL FIELD

The present disclosure relates to an opto-electric connection component and an information device.

### BACKGROUND

JP2011-119698A discloses an electronic equipment incorporating an electric cable provided with connectors at both ends. In this electronic equipment, the electrical cable passes through a hinge portion. JPH06-131077A and JP2001-154760A disclose another openable electronic equipment with a hinge portion.

### SUMMARY

An opto-electric connection component according to an embodiment of the present disclosure includes a first terminal member, a second terminal member, at least one optical fiber, and at least one metal wire. The optical fiber includes a first end and a second end located opposite to the first end. The first end of the optical fiber is connected to the first terminal member and the second end of the optical fiber is connected to the second terminal member. The metal wire includes a first end and a second end located opposite to the first end. The first end of the metal wire is connected to the first terminal member and the second end of the metal wire is connected to the second terminal member.

### BRIEF DESCRIPTION OF THE DRAWINGS

FIG. 1 is a perspective view showing an example of an information device according to an embodiment.

FIG. 2 is a plan view showing an opto-electric connection component according to a first embodiment.

FIG. 3 is a plan view showing an opto-electric connection component according to a second embodiment.

FIG. 4 is a plan view showing an opto-electric connection component according to a third embodiment.

FIG. 5 is a plan view showing an opto-electric connection component according to a fourth embodiment.

FIG. 6 is a plan view showing an opto-electric connection component according to a fifth embodiment.

FIG. 7 is a cross-sectional view showing the opto-electric connection component shown in FIG. 6 taken along line VII-VII.

FIG. 8 is a plan view showing an opto-electric connection component according to a sixth embodiment.

### DETAILED DESCRIPTION

In various electronic devices, it is desired to increase transmission capacity between electric components respectively attached to two housings rotatably connected at a hinge portion. When the number of electrical wirings is simply increased to increase the transmission capacity, it hinders the miniaturization or thinning of the electronic devices. Thus, in various electronic devices, it is desired to reduce the size or thickness of the electronic devices while increasing the transmission capacity.

An object of the present disclosure is to provide a connection component capable of reducing the size or thickness of an electronic device while increasing transmission capacity, and an electronic device including the connection component.

First, the contents of embodiments of the present disclosure will be listed and described.

An opto-electric connection component according to an embodiment includes a first terminal member, a second terminal member, at least one optical fiber including a first end and a second end located opposite to the first end, the first end and the second end being connected to the first terminal member and the second terminal member, respectively, and at least one metal wire including a first end and a second end located opposite to the first end, the first end and the second end being connected to the first terminal member and the second terminal member, respectively.

An opto-electric connection component according to another embodiment includes a first terminal member, a second terminal member, a third terminal member, a fourth terminal member, at least one optical fiber including a first end and a second end located opposite to the first end, the first end and the second end being connected to the first terminal member and the second terminal member, respectively, and at least one metal wire including a first end and a second end located opposite to the first end, the first end and the second end being connected to the third terminal member and the fourth terminal member, respectively.

The opto-electric connection component of [1] or [2] includes the optical fiber in addition to the metal wire. This can significantly increase transmission capacity compared to electrical wiring alone. In addition, since the transmission capacity is greatly increased, the number of required wiring lines is reduced, and thus the electronic device on which the connection component is mounted can be miniaturized or thinned.

In the opto-electric connection component of the above [2], the first terminal member and the third terminal member may be configured to constitute a common terminal member. In this case, one terminal member can be shared. This enables the connection component to be reduced in size.

In the opto-electric connection component according to any one of the above [1] to [3], the optical fiber and the metal wire may be at least partially twisted together in a longitudinal direction. In this case, the optical fiber and the metal wire can be handled as an integrated body, and the opto-electric connection component can be easily attached. In addition, since a cross-section area of the optical fiber and the metal wire can be reduced by twisting the optical fiber and the metal wire, electronic device can be made smaller or thinner.

In the opto-electric connection component according to any one of the above [1] to [4], the optical fiber and the metal wire may be partially twisted together in a longitudinal direction, and a hinge portion configured to allow the optical fiber and the metal wire to pass therethrough may be positioned at a location where the optical fiber and the metal wire are partially twisted together. In this case, since the optical fiber and the metal wire are integrated by twisting in the hinge portion where a passing region is narrowed, the opto-electric connection component can be easily passed through the hinge portion, and the opto-electric connection component can be easily attached in the electronic device.

In the opto-electric connection component according to any one of the above [1] to [5], the optical fiber and the metal wire may be twisted together by winding the metal wire around the optical fiber, with the optical fiber serving as a reference. In this case, since the metal wire is wound around the optical fiber, it is possible to prevent an increase in transmission loss due to bending of the optical fiber. In addition, since the optical fiber is protected by the metal wire, it is possible to prevent an increase in transmission loss of the optical fiber due to application of external force.

In the opto-electric connection component according to any one of the above [1] to [6], the at least one metal wire may include a plurality of metal wires greater in number than the at least one optical fiber. Two or more of the metal wires may be twisted with the optical fiber. In this case, the optical fiber is protected by two or more metal wires.

The opto-electric connection component according to any one of the above [1] to [7] may further include a holding portion configured to hold at least a portion in a longitudinal direction of the optical fiber and at least a portion in the longitudinal direction of the metal wire. In this case, the optical fiber and the metal wire can be handled as integrated body by the holding portion, and the opto-electric connection component can be easily attached.

In the opto-electric connection component of the above, the holding portion may be formed of a pair of laminate materials bonded together. In this case, the holding portion can be easily manufactured. In addition, since the holding portion can be manufactured using the laminate materials while checking the arrangement of the optical fiber and the metal wire, the positional accuracy of the optical fiber and the metal wire can be improved.

In the opto-electric connection component of the above [8] or [9], the holding portion may be configured to hold the optical fiber and the metal wire such that the optical fiber and the metal wire are separated from each other. In this case, mutual influence between the optical fiber and the metal wire can be prevented.

In the opto-electric connection component according to any one of the above [1] and [4] to , the first terminal member may include a first board, a first optical component disposed on the first board and optically connected to the first end of the optical fiber, and a first connection terminal disposed on the first board and connected to the first end of the metal wire. The second terminal member may include a second board, a second optical component disposed on the second board and optically connected to the second end of the optical fiber, and a second connection terminal disposed on the second board and connected to the second end of the metal wire. The first optical component may include at least one of a light-receiving element and a light-emitting element, and the second optical component may include at least one of a light-receiving element and a light-emitting element. In this case, the opto-electric connection component can be easily attached to an information device or the like by using the first terminal member and the second terminal member. In the present disclosure, the phrase “at least one of a light-receiving element and a light-emitting element” means “a light-receiving element, a light-emitting element, one or more light-receiving elements, one or more light-emitting elements, or one or more light-receiving elements and one or more light-emitting elements”.

As another aspect, the present disclosure relates to an information device. The information device includes the opto-electric connection component according to any one of the above [1] to , a first device component, and a second device component. The first device component is connected to the first terminal member. The second device component is connected to the second terminal member. In this case, the information device can be configured to have significantly increased transmission capacity compared to the electrical wiring alone. In addition, the connection component can greatly increase the transmission capacity, so that the number of required wiring lines can be reduced, and the information device can be made smaller or thinner.

Specific examples of an opto-electric connection component and an information device according to an embodiment of the present disclosure will be described below with reference to the drawings. In the following description, the same reference numerals are used for the same elements or elements having the same functions, and redundant description will be omitted. The present invention is not limited to these examples, but is defined by the scope of the claims, and is intended to include all modifications within the meaning and scope equivalent to the scope of the claims.

### [First Embodiment]

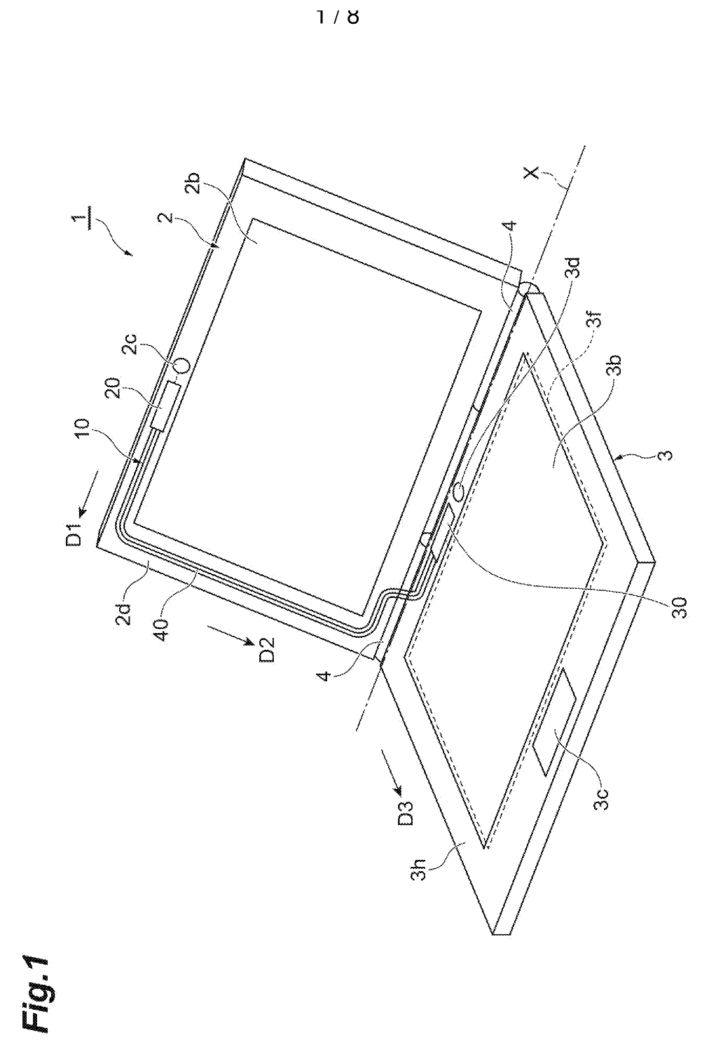

An example of an information device in which an opto-electric connection component according to the present embodiment is mounted will be described with reference to FIG. 1. As shown in FIG. 1, an information device 1 is, for example, a notebook computer. The information device 1 includes a monitor portion 2, a body portion 3, and a hinge portion 4. The monitor portion 2 includes, for example, a display 2b, a camera 2c, and a frame portion 2d. The display 2b is, for example, a liquid crystal display, and the camera 2c is a Web camera. The display 2b and the camera 2c are driven by receiving electric signals.

The frame portion 2d is a portion formed in a frame shape in the monitor portion 2. The frame portion 2d holds, for example, the display 2b and the camera 2c. For example, the frame portion 2d is formed in a rectangular plate shape. In this case, the frame portion 2d has long sides extending in a first direction D1 and short sides extending in a second direction D2 orthogonal to the first direction D1. The first direction D1 is a direction in which a rotation axis X of the hinge portion 4 extends. The second direction D2 is a direction that is orthogonal to the first direction D1, extends along the frame portion 2d, and approaches the hinge portion 4.

The body portion 3 includes a keyboard 3b, a touch pad 3c, a power button 3d, a motherboard 3f, and a frame portion 3h. Each of the keyboard 3b, the touch pad 3c, and the power button 3d is electrically connected to the motherboard 3f. The keyboard 3b, the touch pad 3c, and the power button 3d are portions operated by a user of the information device 1. Signals are output from the motherboard 3f to the respective units of the information device 1, and the respective units of the information device 1 function by operating each of the keyboard 3b, the touch pad 3c, and the power button 3d.

The frame portion 3h is a portion formed in a frame shape in the body portion 3. The frame portion 3h holds the keyboard 3b, the touch pad 3c, and the power button 3d, and houses the motherboard 3f. For example, the frame portion 3h is formed in a rectangular plate shape. In this case, the frame portion 3h has long sides extending in the first direction D1 and short sides extending in a third direction D3 intersecting the first direction D1. The third direction D3 is a direction that is orthogonal to the first direction D1, extends along the frame portion 3h, and is away from the hinge portion 4.

The hinge portion 4 is a portion that enables the monitor portion 2 to rotate with respect to the body portion 3 about the rotation axis X. The hinge portion 4 is, for example, tubular. As an example, the information device 1 has two hinge portions 4 arranged in the first direction D1. However, the shape and number of the hinge portions 4 are not particularly limited. The hinge portion 4 is configured to allow an opto-electric connection component 10, which will be described in detail later, to pass therethrough.

The information device 1 further includes an opto-electric connection component 10. The opto-electric connection component 10 is incorporated in the information device 1. In FIG. 1, for the sake of easy understanding of the drawing, the opto-electric connection component 10, which is a wiring structure incorporated in the information device 1, is shown by a solid line. A plurality of components constituting the information device 1 are electrically and optically connected to each other by the opto-electric connection component 10. For example, the camera 2c and the motherboard 3f are electrically and optically connected to each other by the opto-electric connection component 10. The electrical connection enables the camera 2c to be electrically driven. The optical connection allows image data and audio data acquired by the camera 2c to be transmitted to the motherboard 3f. As is apparent to those skilled in the art, the operation by the electrical connection and the optical connection by the opto-electric connection component 10 is not limited to these, can be applied to various types, and a detailed description thereof will be omitted.

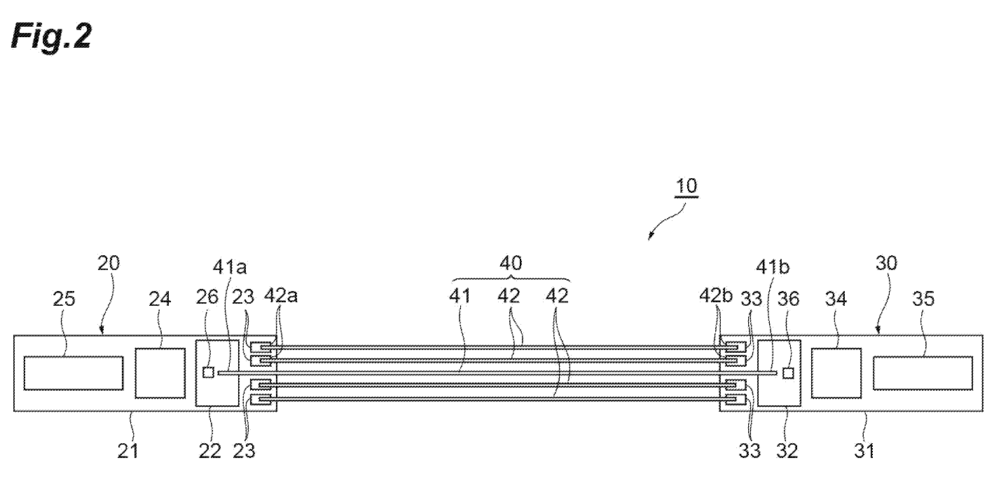

Next, an example of the opto-electric connection component 10 will be described with reference to FIG. 2. As shown in FIG. 2, the opto-electric connection component 10 includes a first terminal member 20, a second terminal member 30, and a wiring portion 40. The wiring portion 40 includes at least one optical fiber 41 and at least one metal wire 42. In the example shown in FIG. 2, the wiring portion 40 includes one optical fiber 41 and four metal wires, but is not limited thereto, and may include two or more optical fibers 41 or only one metal wire. The wiring portion 40 is configured to pass through the hinge portion 4 of the information device 1. Specifically, the wiring lines are aggregated (bundled) at least in a portion so that the optical fiber 41 and the metal wire 42 of the wiring portion 40 have a cross-section small enough to pass through the hinge portion 4.

The optical fiber 41 has a first end 41a and a second end 41b located opposite to the first end 41a. The first end 41a of the optical fiber 41 is connected to the first terminal member 20, and the second end 41b of the optical fiber 41 is connected to the second terminal member 30. Each metal wire 42 has a first end 42a and a second end 42b opposite to the first end 42a. The first end 42a of the metal wire 42 is connected to the first terminal member 20, and the second end 42b of the metal wire 42 is connected to the second terminal member 30.

The first terminal member 20 is, for example, a member that is disposed close to the camera 2c of the monitor portion 2 of the information device 1 and is connected to the camera 2c. The first terminal member 20 includes a first board 21, a first optical component 22 disposed on the first board 21 and optically connected to the first end 41a of the optical fiber 41, a first connection terminal 23 disposed on the first board 21 and connected to the first end 42a of the metal wire 42, a control IC 24, and a connector 25. The first optical component 22 is provided with an optical element 26 including a light-emitting element or a light-receiving element and a lens member. The first end 41a of the optical fiber 41 is optically coupled to the optical element 26 by the lens member. As an example, the optical element 26 may be mounted on the first board 21. In this case, the first optical component 22 converts light extending in a direction parallel to the first board 21 into a direction orthogonal to the first board 21.

The control IC 24 controls processing such as photoelectric conversion in the optical element 26 of the first optical component 22. When the optical element 26 is a light-receiving element, the control IC 24 outputs the photoelectrically converted electrical signal to the connector 25. When the optical element 26 is a light-emitting element, the control IC 24 sends an electric signal (for example, image information from the camera 2c) input from the connector 25 to the optical element 26, causes the electric signal to be photoelectrically converted, and causes the resulting light to be incident on the optical fiber 41.

The connector 25 is a member that is directly or indirectly connected to an electric component (for example, the camera 2c) incorporated in the information device 1 (see FIG. 1) to which the opto-electric connection component 10 is attached. Various connectors can be used as the connector 25.

The second terminal member 30 is a member that is disposed near the motherboard 3f of the body portion 3 of the information device 1 and is connected to the motherboard 3f, for example. The second terminal member 30 includes a second board 31, a second optical component 32 disposed on the second board 31 and optically connected to the second end 41b of the optical fiber 41, a second connection terminal 33 disposed on the second board 31 and connected to the second end 42b of the metal wire 42, a control IC 34, and a connector 35. The second optical component 32 is provided with an optical element 36 including a light-emitting element or a light-receiving element and a lens member. The second terminal member 30 has a structure similar to that of the first terminal member 20, and the second board 31, the second optical component 32, the second connection terminal 33, the control IC 34, the connector 35, and the optical element 36 have functions similar to those of the first board 21, the first optical component 22, the first connection terminal 23, the control IC 24, the connector 25, and the optical element 26, and thus a detailed description thereof will be omitted.

The opto-electric connection component 10 and the information device 1 including the opto-electric connection component 10 according to the present embodiment include the optical fiber 41 in addition to the metal wire 42. This can significantly increase the transmission capacity compared to electrical wiring alone. In addition, since the transmission capacity is greatly increased, the number of required wiring lines is reduced, and thus the electronic device on which the connection component is mounted can be miniaturized or thinned. Further, the opto-electric connection component 10 is configured such that the optical fiber 41 and the metal wire 42 can pass through the hinge portion 4. Thus, a cross-section area of the wiring portion 40 including the optical fiber 41 and the metal wire 42 is reduced. Thus, also in this respect, the electronic device can be reduced in size or thickness.

### Second Embodiment

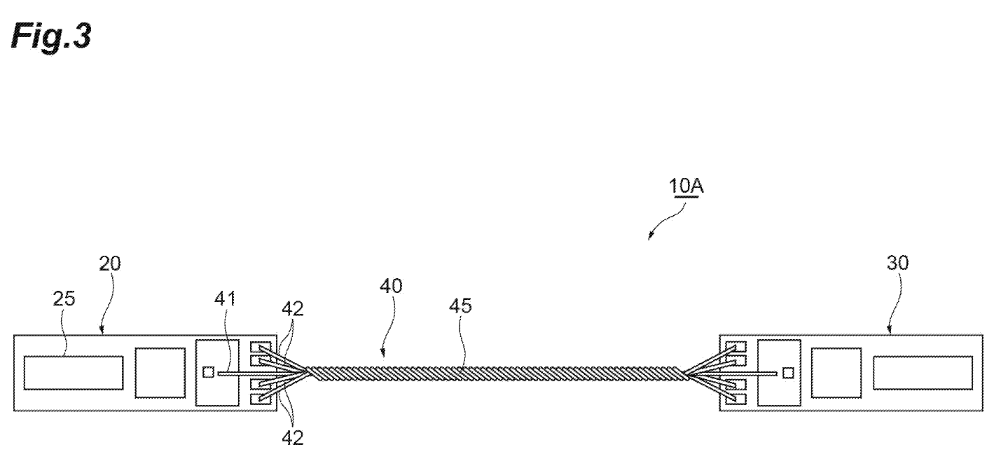

Next, an opto-electric connection component according to a second embodiment will be described with reference to FIG. 3. As shown in FIG. 3, an opto-electric connection component 10A includes the first terminal member 20, the second terminal member 30, and the wiring portion 40. The wiring portion 40 includes at least one optical fiber 41 and at least one metal wire 42. In the wiring portion 40 according to the second embodiment, the optical fiber 41 and the metal wire 42 are twisted together to form a twisted portion 45. The twisted portion 45 is formed in the longitudinal direction of the optical fiber 41 and the like over substantially the entire length. In the twisted portion 45, the respective wiring lines are twisted together to reduce the cross-section area, and thus, the wires can easily pass through the hinge portion 4. In the twisted portion 45, the optical fiber 41 and the metal wire 42 may be twisted together by winding the metal wire 42 around the optical fiber 41, with the optical fiber 41 serving as a reference, or may be twisted in the opposite manner, or the optical fiber 41 and the metal wire 42 may be twisted as the same wiring line. The other structures are similar to those of the opto-electric connection component 10 according to the first embodiment. This opto-electric connection component 10A can also be mounted on the information device 1.

The opto-electric connection component 10A and the information device 1 including the opto-electric connection component 10A according to the present embodiment include the optical fiber 41 in addition to the metal wire 42, as in the first embodiment. This can significantly increase the transmission capacity compared to electrical wiring alone. In addition, since the transmission capacity is greatly increased, the number of required wiring lines is reduced, and thus the electronic device on which the connection component is mounted can be miniaturized or thinned. Further, the opto-electric connection component 10A is configured such that the optical fiber 41 and the metal wire 42 can easily pass through the hinge portion 4 by the twisted portion 45. Thus, a cross-section area of the wiring portion 40 including the optical fiber 41 and the metal wire 42 is reduced. Thus, also in this respect, the electronic device can be reduced in size or thickness. In addition, in the opto-electric connection component 10A, the optical fiber 41 and the metal wire 42 can be handled as an integrated body by the twisted portion 45, and the opto-electric connection component 10A can be easily attached to the information device 1 or the like.

### Third Embodiment

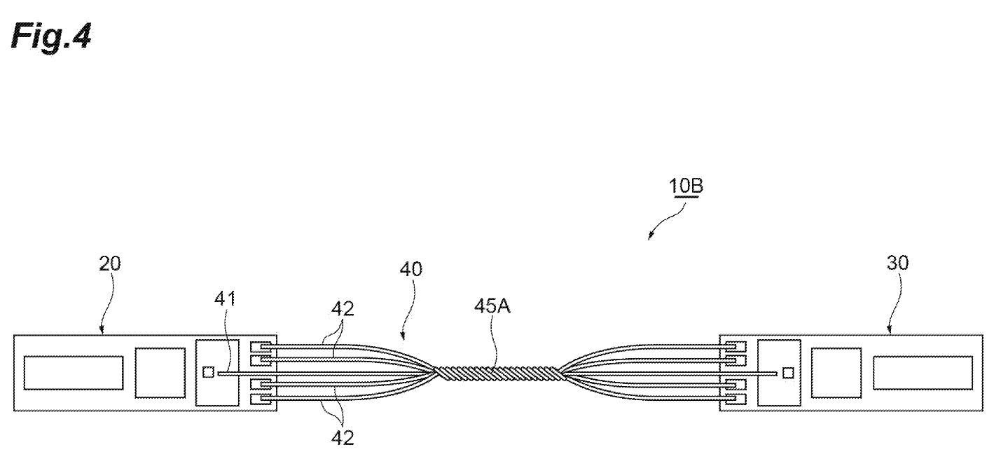

Next, an opto-electric connection component according to a third embodiment will be described with reference to FIG. 4. As shown in FIG. 4, an opto-electric connection component 10B includes the first terminal member 20, the second terminal member 30, and the wiring portion 40. The wiring portion 40 includes at least one optical fiber 41 and at least one metal wire 42. In the wiring portion 40 according to the third embodiment, the optical fiber 41 and the metal wire 42 are partially twisted together in the longitudinal direction to form a twisted portion 45A. In the twisted portion 45A, the respective wiring lines are twisted together to reduce the cross-section area as in the second embodiment, and thus, the wiring lines can easily pass through the hinge portion 4. That is, in the opto-electric connection component 10B according to the third embodiment, the twisted portion 45A is provided so as to correspond to the hinge portion 4. The other structures are similar to those of the opto-electric connection components 10 and 10A according to the first embodiment and the second embodiment. This opto-electric connection component 10B can also be mounted on the information device 1.

The opto-electric connection component 10B and the information device 1 including the opto-electric connection component 10B according to the present embodiment include the optical fiber 41 in addition to the metal wire 42, as in the first embodiment and the like. This can significantly increase the transmission capacity compared to electrical wiring alone. In addition, since the transmission capacity is greatly increased, the number of required wiring lines is reduced, and thus the electronic device on which the connection component is mounted can be miniaturized or thinned. Further, the opto-electric connection component 10B is configured such that the optical fiber 41 and the metal wire 42 can easily pass through the hinge portion 4 by the twisted portion 45A. Thus, a cross-section area of the wiring portion 40 including the optical fiber 41 and the metal wire 42 is reduced. Thus, also in this respect, the electronic device can be reduced in size or thickness. In addition, in the opto-electric connection component 10B, the optical fiber 41 and the metal wire 42 can be handled as an integrated body by the twisted portion 45A, and the opto-electric connection component 10B can be easily attached to the information device 1 or the like.

### Fourth Embodiment

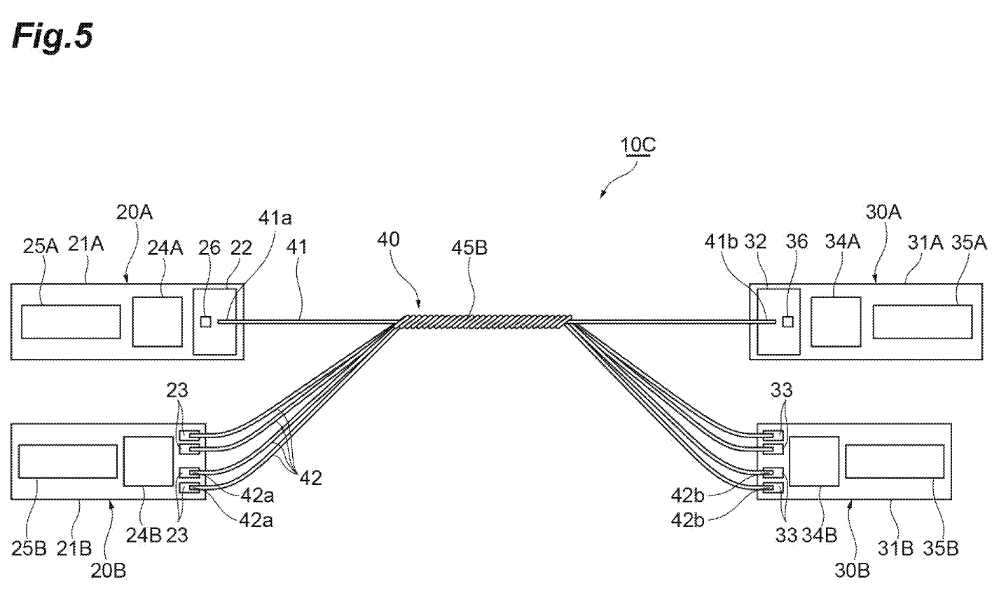

Next, an opto-electric connection component according to a fourth embodiment will be described with reference to FIG. 5. As shown in FIG. 5, an opto-electric connection component 10C includes a first terminal member 20A, a second terminal member 30A, a third terminal member 20B, a fourth terminal member 30B, and the wiring portion 40. The wiring portion 40 includes at least one optical fiber 41 and at least one metal wire 42.

The first terminal member 20A and the third terminal member 20B correspond to the first terminal member 20 of the first embodiment. The first end 41a of the optical fiber 41 is connected to the first terminal member 20A, and the first end 42a of the metal wire 42 is connected to the third terminal member 20B. The first terminal member 20A includes a first board 21A, the first optical component 22 disposed on the first board 21A and connected to the first end 41a of the optical fiber 41, a control IC 24A, and a connector 25A. The first optical component 22 is provided with a lens member and the optical element 26. The control IC 24A controls the optical element 26. The third terminal member 20B includes a third board 21B, the first connection terminal 23 disposed on the third board 21B and connected to the first end 42a of the metal wire 42, a control IC 24B, and a connector 25B. The control IC 24B controls an electric signal and a voltage.

The second terminal member 30A and the fourth terminal member 30B correspond to the second terminal member 30 of the first embodiment. The second terminal member 30A is connected to the second end 41b of the optical fiber 41, and the fourth terminal member 30B is connected to the second end 42b of the metal wire 42. The second terminal member 30A includes a second board 31A, the second optical component 32 disposed on the second board 31A and connected to the second end 41b of the optical fiber 41, a control IC 34A, and a connector 35A. The second optical component 32 is provided with a lens member and the optical element 36. The control IC 34A controls the optical element 36. The fourth terminal member 30B includes a fourth board 31B, the second connection terminal 33 disposed on the fourth board 31B and connected to the second end 42b of the metal wire 42, a control IC 34B, and a connector 35B. The control IC 34B controls an electric signal and a voltage.

In the wiring portion 40 according to the fourth embodiment, the optical fiber 41 and the metal wire 42 are at least partially twisted together in the longitudinal direction to form a twisted portion 45B, as in the second embodiment and the third embodiment. The twisting method is similar to that of the second embodiment or the like. In the twisted portion 45B, the respective wiring lines are twisted together to reduce the cross-section area, and thus, the wires can easily pass through the hinge portion 4 of the information device 1. The twisted portion 45B may be provided in a part of the wiring portion 40 so as to correspond to the hinge portion 4. The other structures are similar to those of the opto-electric connection component 10 and the like according to the first embodiment. This opto-electric connection component 10C can also be mounted on the information device 1.

The opto-electric connection component 10C and the information device 1 including the opto-electric connection component 10C according to the present embodiment include the optical fiber 41 in addition to the metal wire 42, as in the first embodiment and the like. This can significantly increase the transmission capacity compared to electrical wiring alone. In addition, since the transmission capacity is greatly increased, the number of required wiring lines is reduced, and thus the electronic device on which the connection component is mounted can be miniaturized or thinned. Further, the opto-electric connection component 10C is configured such that the optical fiber 41 and the metal wire 42 can easily pass through the hinge portion 4 by the twisted portion 45B. Thus, the cross-section area of the wiring portion 40 including the optical fiber 41 and the metal wire 42 is reduced. Thus, also in this respect, the electronic device can be reduced in size or thickness. In the opto-electric connection component 10C, the optical fiber 41 and the metal wire 42 can be handled as an integrated body by the twisted portion 45B, and the opto-electric connection component 10C can be easily attached to the information device 1 or the like. In the opto-electric connection component 10C, a terminal member for optical connection and a terminal member for electric connection are separately provided, and thus, when the opto-electric connection component 10C is mounted on the information device 1, the degree of freedom of design can be improved.

### Fifth Embodiment

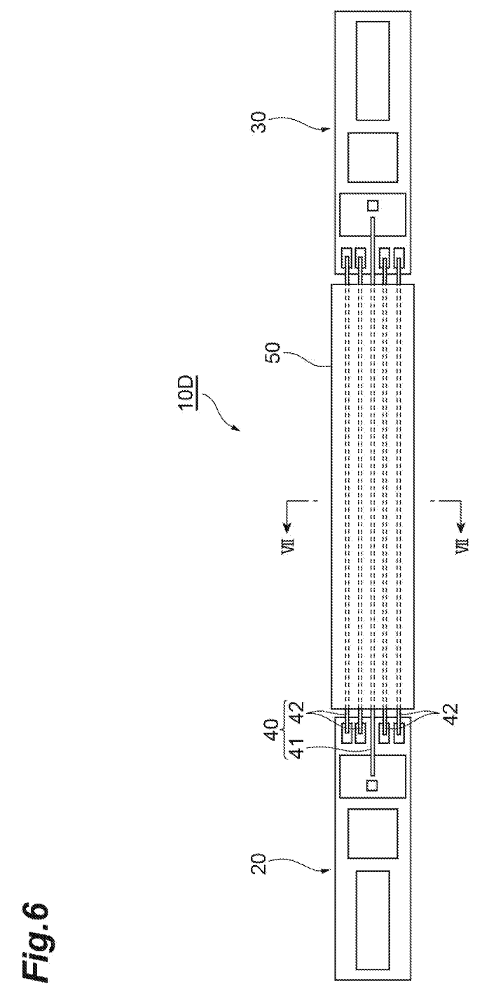

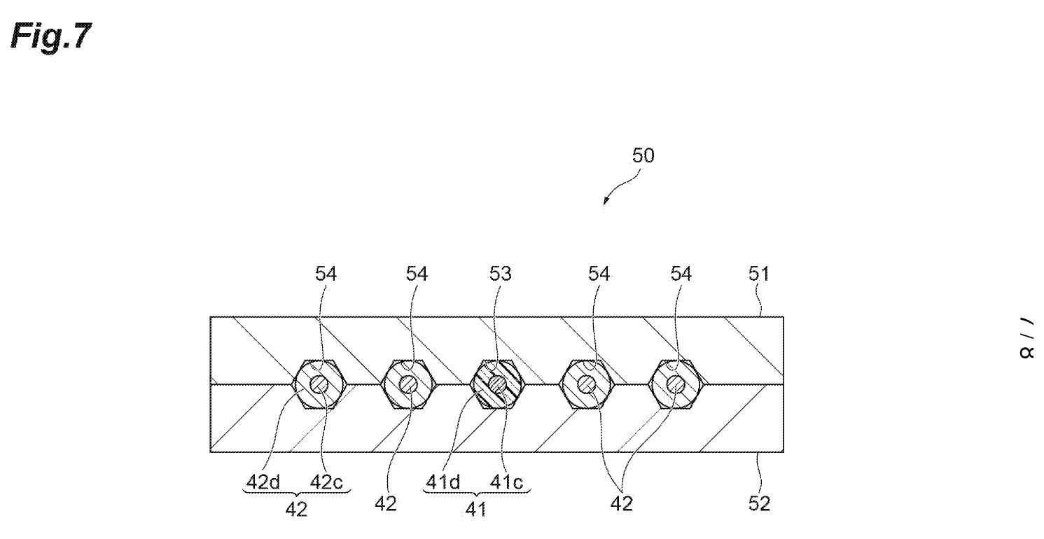

Next, an opto-electric connection component according to a fifth embodiment will be described with reference to FIGS. 6 and 7. As shown in FIGS. 6 and 7, an opto-electric connection component 10D includes the first terminal member 20, the second terminal member 30, and the wiring portion 40. The wiring portion 40 includes at least one optical fiber 41 and at least one metal wire 42. The opto-electric connection component 10D according to the fifth embodiment further includes a holding portion 50 that holds the optical fiber 41 and the metal wire 42. The holding portion 50 is formed by, for example, disposing the optical fiber 41 and the metal wire 42 between a pair of laminate materials 51 and 52 and laminating the laminate materials 51 and 52. As shown in FIG. 7, the optical fiber 41 and the metal wire 42 are accommodated in accommodating portions 53 and 54 of the holding portion 50 so as to be separated from each other. The optical fiber 41 may include a glass portion 41c and a covering portion 41d covering the glass portion 41c, and the metal wire 42 may include a metal portion 42c and a covering portion 42d covering the metal portion 42c. The optical fiber 41 has such the covering portion 41d, thereby reducing the influence of external force applied to the optical fiber. The metal portion 42c has such the covering portion 42d, thereby being insulated from each other. However, the laminate materials 51 and 52 may perform some or all of the functions of the covering portion. The structure of the covering is similar to that of the optical fiber 41 and the metal wire 42 in the first embodiment to fourth embodiment.

The opto-electric connection component 10D and the information device 1 including the opto-electric connection component 10D according to the present embodiment include the optical fiber 41 in addition to the metal wire 42, as in the first embodiment and the like. This can significantly increase the transmission capacity compared to electrical wiring alone. In addition, since the transmission capacity is greatly increased, the number of required wiring lines is reduced, and thus the electronic device on which the connection component is mounted can be miniaturized or thinned. Further, the opto-electric connection component 10D is configured such that the optical fiber 41 and the metal wire 42 can easily pass through the hinge portion 4 by the holding portion 50. Thus, a cross-section area of the wiring portion 40 including the optical fiber 41 and the metal wire 42 is reduced. Thus, also in this respect, the electronic device can be reduced in size or thickness. In addition, in the opto-electric connection component 10D, the optical fiber 41 and the metal wire 42 can be handled as an integrated body by the holding portion 50, and the opto-electric connection component 10D can be easily attached to the information device 1 or the like.

### Sixth Embodiment

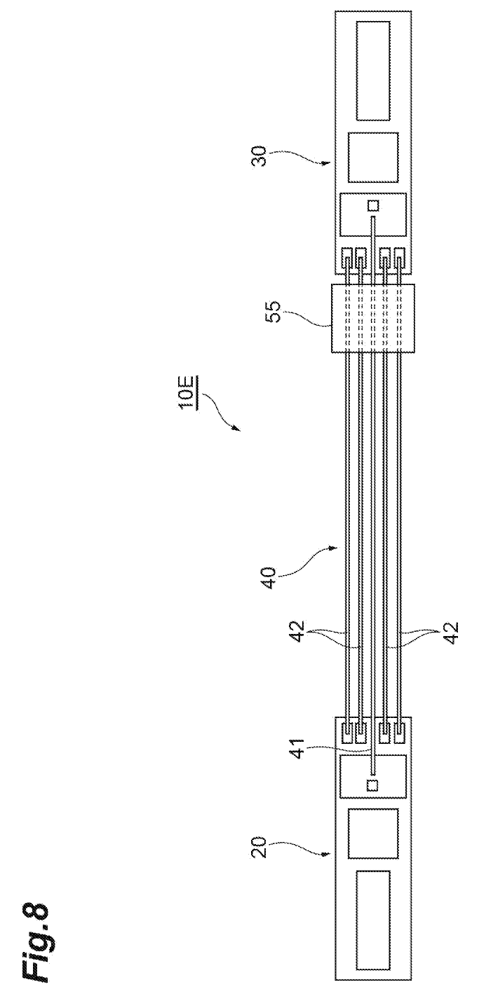

Next, an opto-electric connection component according to a sixth embodiment will be described with reference to FIG. 8. As shown in FIG. 8, an opto-electric connection component 10E includes the first terminal member 20, the second terminal member 30, the wiring portion 40, and a holding portion 55. The holding portion 55 is a member similar to the holding portion 50 of the fifth embodiment, and has a shorter length. Even with the holding portion having such a length, effects similar to those of the fifth embodiment can be achieved.

Although the opto-electric connection component and the information device having the opto-electric connection component according to the present disclosure have been described in detail, the present disclosure is not limited to the above embodiments and can be applied to various embodiments and modifications. For example, in the fourth embodiment (see FIG. 5) described above, the optical fiber 41 and the metal wire 42 do not have to be twisted. In the fourth embodiment, the first terminal member 20A and the third terminal member 20B may be configured to constitute a single common terminal (i.e., first terminal member 20), or the second terminal member 30A and the fourth terminal member 30B may be configured to constitute a single common terminal (i.e., second terminal member 30).

In the second embodiment to fourth embodiment described above, when the optical fiber 41 and the metal wire 42 are twisted together, the optical fiber 41 and the metal wire 42 may be twisted together by winding the metal wire 42 around the optical fiber 41, with the optical fiber 41 serving as a reference. In this case, since the metal wire 42 is wound around the optical fiber 41, it is possible to prevent an increase in transmission loss due to bending of the optical fiber 41. In addition, since the optical fiber 41 is protected by the metal wire 42, it is possible to prevent an increase in transmission loss of the optical fiber 41 due to application of external force.

In addition, in the second embodiment to fourth embodiment described above, the covering portion 42d of the metal wire 42 may have a lower Young's modulus than the covering portion 41d of the optical fiber 41. In this case, the lateral pressure applied to the optical fiber 41 is reduced by the covering portion 42d of the metal wire 42. Thus, the transmission loss of the optical fiber 41 is prevented from increasing.

What is claimed is:

1. An opto-electric connection component comprising:
a first terminal member;
a second terminal member;
at least one optical fiber including a first end and a second end located opposite to the first end, the first end and the second end being connected to the first terminal member and the second terminal member, respectively; and
at least one metal wire including a first end and a second end located opposite to the first end, the first end and the second end being connected to the first terminal member and the second terminal member, respectively.

2. An opto-electric connection component comprising:
a first terminal member;
a second terminal member;
a third terminal member;
a fourth terminal member;
at least one optical fiber including a first end and a second end located opposite to the first end, the first end and the second end being connected to the first terminal member and the second terminal member, respectively; and
at least one metal wire including a first end and a second end located opposite to the first end, the first end and the second end being connected to the third terminal member and the fourth terminal member, respectively.

3. The opto-electric connection component according to claim 2,
wherein the first terminal member and the third terminal member are configured to constitute a common terminal member.

4. The opto-electric connection component according to claim 1,
wherein the optical fiber and the metal wire are at least partially twisted together in a longitudinal direction.

5. The opto-electric connection component according to claim 1,
wherein the optical fiber and the metal wire are partially twisted together in a longitudinal direction, and a hinge portion configured to allow the optical fiber and the metal wire to pass therethrough is positioned at a location where the optical fiber and the metal wire are partially twisted together.

6. The opto-electric connection component according to claim 1,
wherein the optical fiber and the metal wire are twisted together by winding the metal wire around the optical fiber, with the optical fiber serving as a reference.

7. The opto-electric connection component according to claim 1,
wherein the at least one metal wire includes a plurality of metal wires greater in number than the at least one optical fiber, and
wherein two or more of the metal wires are twisted with the optical fiber.

8. The opto-electric connection component according to claim 1, further comprising:
a holding portion configured to hold at least a portion in a longitudinal direction of the optical fiber and at least a portion in the longitudinal direction of the metal wire.

9. The opto-electric connection component according to claim 8,
wherein the holding portion is formed of a pair of laminate materials bonded together.

10. The opto-electric connection component according to claim 8,
wherein the holding portion is configured to hold the optical fiber and the metal wire such that the optical fiber and the metal wire are separated from each other.

11. The opto-electric connection component according to claim 1,
wherein the first terminal member includes a first board, a first optical component disposed on the first board and optically connected to the first end of the optical fiber, and a first connection terminal disposed on the first board and connected to the first end of the metal wire,
wherein the second terminal member includes a second board, a second optical component disposed on the second board and optically connected to the second end of the optical fiber, and a second connection terminal disposed on the second board and connected to the second end of the metal wire, and
wherein the first optical component includes at least one of a light-receiving element and a light-emitting element, and the second optical component includes at least one of a light-receiving element and a light-emitting element.

12. An information device comprising:
the opto-electric connection component according to claim 1;
a first device component; and
a second device component,
wherein the first device component is connected to the first terminal member, and
wherein the second device component is connected to the second terminal member.

13. The opto-electric connection component according to claim 2,
wherein the optical fiber and the metal wire are at least partially twisted together in a longitudinal direction.

14. The opto-electric connection component according to claim 2,
wherein the optical fiber and the metal wire are partially twisted together in a longitudinal direction, and a hinge portion configured to allow the optical fiber and the metal wire to pass therethrough is positioned at a location where the optical fiber and the metal wire are partially twisted together.

15. The opto-electric connection component according to claim 2,
wherein the optical fiber and the metal wire are twisted together by winding the metal wire around the optical fiber, with the optical fiber serving as a reference.

16. The opto-electric connection component according to claim 2,
wherein the at least one metal wire includes a plurality of metal wires greater in number than the at least one optical fiber, and
wherein two or more of the metal wires are twisted with the optical fiber.

17. The opto-electric connection component according to claim 2, further comprising:
a holding portion configured to hold at least a portion in a longitudinal direction of the optical fiber and at least a portion in the longitudinal direction of the metal wire.

18. The opto-electric connection component according to claim 17,
wherein the holding portion is formed of a pair of laminate materials bonded together.

19. The opto-electric connection component according to claim 17,
wherein the holding portion is configured to hold the optical fiber and the metal wire such that the optical fiber and the metal wire are separated from each other.

20. An information device comprising:
the opto-electric connection component according to claim 2;
a first device component; and
a second device component,
wherein the first device component is connected to the first terminal member, and
wherein the second device component is connected to the second terminal member.
